(19) United States
(12) Patent Application Publication
(10) Pub. No.: US 2023/0103973 A1
(43) Pub. Date: Apr. 6, 2023

(54) PASSIVE PHASE SEPARATOR WITH LIQUID REMOVAL CHAMBER

(71) Applicant: Hamilton Sundstrand Corporation, Charlotte, NC (US)

(72) Inventors: Ashley Rose Himmelmann, Beloit, WI (US); Robert J. Roy, West Springfield, MA (US)

(21) Appl. No.: 17/484,660

(22) Filed: Sep. 24, 2021

(51) Int. Cl. B01D 19/00

(52) U.S. Cl. CPC B01D 19/0073; B01D 19/0068

(57) ABSTRACT

A passive phase separator includes an input conduit including an inlet through which multi-phase flow enters the input conduit and a gas conduit formed at an angle from the input conduit. A liquid removal chamber is formed in line with the input conduit. The gas conduit is closer to the inlet than the liquid removal chamber. The liquid removal chamber holds liquid from the multi-phase flow, and the gas conduit carries gas from the multi-phase flow.

### BACKGROUND

Exemplary embodiments pertain to the art of phase separation and, in particular, to a passive phase separator with a liquid removal chamber.

Phase separation is required in a variety of multi-phase systems. For example, in certain environments (e.g., space vehicle or habitat), a heat exchanger may be used to revitalize air through condensing, cooling, filtering, and humidifying. This can result in a multi-phase product, specifically a mix of water and air. In a zero-gravity environment such as the space environment, condensation of water and its separation from the remaining gaseous phase presents a technical challenge. Any water droplets remaining in the gas (e.g., cabin air) may impede the function of various equipment (e.g., soak the filter) or coalesce to form a potential hazard (e.g., within a space vehicle, life support suit, space station, habitat).

### BRIEF DESCRIPTION

In one exemplary embodiment, a passive phase separator includes an input conduit including an inlet through which multi-phase flow enters the input conduit and a gas conduit formed at an angle from the input conduit. A liquid removal chamber is formed in line with the input conduit. The gas conduit is closer to the inlet than the liquid removal chamber. The liquid removal chamber holds liquid from the multi-phase flow and the gas conduit carries gas from the multi-phase flow.

In addition to one or more of the features described herein, the passive phase separator also includes hydrophilic material defining some or all of a perimeter of the liquid removal chamber. The hydrophilic material attracts and passes through the liquid that is water or water-based.

In addition to one or more of the features described herein, the input conduit includes a liquid inlet that forms an opening of the liquid removal chamber on a side of the input conduit opposite the side of the inlet.

In addition to one or more of the features described herein, the passive phase separator also includes a liquid conduit configured to couple to the liquid removal chamber. The liquid that passes through the hydrophilic material enters a volume of the liquid conduit.

In addition to one or more of the features described herein, the liquid removal chamber and the liquid conduit form a liquid capture portion.

In addition to one or more of the features described herein, the liquid capture portion is modular and replaceable.

In addition to one or more of the features described herein, the angle is 90 degrees.

In addition to one or more of the features described herein, the angle is less than 180 degrees.

In addition to one or more of the features described herein, some or all of the input conduit or the gas conduit is formed from or coated with a hydrophobic material.

In another exemplary embodiment, a method of assembling a passive phase separator includes arranging an input conduit with an inlet through which multi-phase flow enters the input conduit and forming a gas conduit at an angle from the input conduit. The method also includes forming a liquid removal chamber in line with the input conduit. The gas conduit is closer to the inlet than the liquid removal chamber. The liquid removal chamber holds liquid from the multi-phase flow and the gas conduit carries gas from the multi-phase flow.

In addition to one or more of the features described herein, the method also includes defining some or all of a perimeter of the liquid removal chamber with a hydrophilic material. The hydrophilic material attracts and passes through the liquid that is water or water-based.

In addition to one or more of the features described herein, the method also includes forming an opening of the liquid removal chamber on a side of the input conduit opposite the side of the inlet as a liquid inlet.

In addition to one or more of the features described herein, the method also includes arranging a liquid conduit to couple to the liquid removal chamber. The liquid that passes through the hydrophilic material enters a volume of the liquid conduit.

In addition to one or more of the features described herein, the method also includes forming a liquid capture portion with the liquid removal chamber and the liquid conduit.

In addition to one or more of the features described herein, the forming the liquid capture portion includes the liquid capture portion being modular and replaceable.

In addition to one or more of the features described herein, the forming the gas conduit includes arranging the gas conduit at a 90 degree angle from the input conduit.

In addition to one or more of the features described herein, the forming the gas conduit includes arranging the gas conduit at the angle less than 180 degrees from the input conduit.

In addition to one or more of the features described herein, the method also includes determining a shape and size of the liquid removal chamber based on characteristics of the multi-phase flow.

In addition to one or more of the features described herein, the multi-phase flow is a flow of water and air and the characteristics include an expected increase in a concentration of the water in portions of the multi-phase flow.

In addition to one or more of the features described herein, the method also includes forming some or all of the input conduit or the gas conduit with a hydrophobic material or coating some or all of the input conduit or the gas conduit with the hydrophobic material.

### BRIEF DESCRIPTION OF THE DRAWINGS

The following descriptions should not be considered limiting in any way. With reference to the accompanying drawings, like elements are numbered alike:

FIG. 1 is a cross-sectional view of relevant aspects of a passive phase separator with a liquid removal chamber according to one or more embodiments; and

FIG. 2A is a cross-sectional view of a capture portion of a passive phase separator according to an exemplary embodiment;

FIG. 2B is a cross-sectional view of a capture portion of a passive phase separator according to an exemplary embodiment; and

FIG. 3 is a process flow of a method of fabricating a passive phase separator with a liquid removal chamber according to one or more embodiments.

### DETAILED DESCRIPTION

A detailed description of one or more embodiments of the disclosed apparatus and method are presented herein by way of exemplification and not limitation with reference to the Figures.

As previously noted, multi-phase flow may have to be separated by a phase separator in a variety of applications. For example, a heat exchanger may be used to revitalize breathable air in space applications and may produce two-phase flow of water and air. As also noted, removing all the water droplets from the heat exchanger before redirecting the air for use in life support may avoid various issues, especially in a zero gravity space environment. Embodiments of the systems and methods detailed herein relate to a passive phase separator with a liquid removal chamber. The multi-phase flow may include two phases (i.e., water and air) that may flow from a condensing heat exchanger to the passive phase separator. As a result of the phase separation, air is allowed to flow to a life support environment (e.g., space suit, space vehicle, habitat) while water is separated and retained for reuse. The passive phase separator according to one or more embodiments includes a liquid removal chamber. In addition to being passive (i.e., requiring no external power), the phase separator according to one or more embodiments facilitates phase separation even for slug flow (i.e., multi-phase flow in which the liquid concentration is higher in some portions that include a “slug of liquid”). The phase separator operates in a zero gravity/microgravity environment with a low pressure drop.

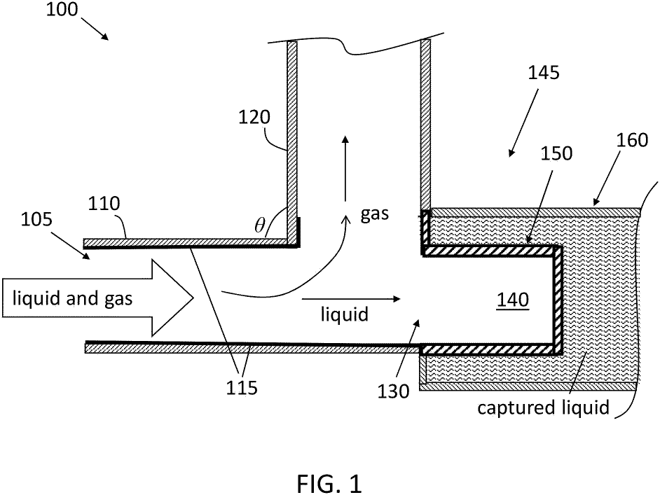

FIG. 1 is a cross-sectional view of relevant aspects of a passive phase separator 100 with a liquid removal chamber 140 according to one or more embodiments. As shown, a two-phase flow of liquid and gas enters the passive phase separator 100 through an inlet 105 of an input conduit 110. This two-phase flow is split between a gas conduit 120 and a liquid removal chamber 140. The gas (e.g., air) in the two-phase flow in the input conduit 110 has lower density than the liquid (e.g., water) in the two-phase flow and follows the turn into the gas conduit 120. Meanwhile, the higher density liquid (e.g., water) in the two-phase flow in the input conduit 110 continues straight through the liquid inlet 130 to the liquid removal chamber 140 based on inertia. The inertial separation is similar to that in an elbow wick, for example. However, the liquid removal chamber 140, according to one or more embodiments, facilitates the inertial separation even when the concentration of liquid in the two-phase flow increases (i.e., slug flow occurs).

A hydrophobic material 115 is shown on the inside of the input conduit 110 and at a corner with the gas conduit 120. In the input conduit 110, the hydrophobic material 115 may prevent water or a water-based liquid in the two-phase flow from separating and clinging to the walls of the input conduit 110. At the corner, the hydrophobic material 115 may discourage collection of liquid at the corner and encourage flow into the liquid removal chamber 140. The hydrophobic material 115 may also be included in the gas conduit 120 where it would maintain the effectiveness of the inertial separation while changing the flow that downstream components see, which may alter their performance. The hydrophobic material 115 may be included as a coating or, in alternate embodiments, may be fabricated as the tubing.

The gas conduit 120, which forms an angle θ with the input conduit 110, may vent the gas (e.g., air) as part of a life support system, for example. The angle θ is shown to be 90 degrees (i.e., gas conduit 120 is perpendicular to the input conduit 110) in FIG. 1, but this exemplary illustration is not intended to be limiting. In alternate embodiments, the angle θ may be based on the expected flow rate and the expected amount of water (e.g., slug concentration) to ensure that inertial separation occurs completely. Lower values of the angle θ may result in relatively better separation of the gas from the liquid but also a relatively higher pressure drop for the gas exiting the gas conduit 120 as compared with gas in the two-phase flow at the inlet 105. Higher pressure drop may mean that more power is needed to move the gas through the passive phase separator 100.

On the other hand, higher values of the angle θ may result in a relatively lower pressure drop but also relatively less separation of the gas from the liquid. For example, if the angle θ were 170 degrees (e.g., almost parallel with the portion of the input conduit 110 that continues through the liquid inlet 130), liquid may flow into the gas conduit 120 as easily as it does into the liquid removal chamber 140. That is, the inertia associated with the liquid, which is more dense than the gas, making the turn into the gas conduit 120 may be too easily overcome if the angle θ were too close to 180 degrees. At the same time, gas moving from the input conduit 110 to the gas conduit 120 may not experience much of a decrease in pressure. The lower the expected concentration and flow rate, the higher the angle θ may be.

In the exemplary embodiment shown in FIG. 1, the liquid removal chamber 140 perimeter is defined by hydrophilic material 150 while its opening is defined by the liquid inlet 130. The hydrophilic material 150 may be in the form of a membrane or metal plate produced from sintered powder, calendared screen, or porous carbon, for example. The hydrophilic material 150 attracts and passes through water or water-based liquid in the liquid removal chamber 140 into a liquid conduit 160 that is coupled to the liquid removal chamber 140. As shown in the exemplary illustration of FIG. 1, the liquid conduit 160 surrounds the liquid removal chamber 140 with a volume therebetween such that liquid flows from the liquid removal chamber 140 through the hydrophilic material 150 into that volume of the liquid conduit 160 (shown with captured liquid in FIG. 1). The liquid conduit 160 may have lower pressure as compared with pressure in the liquid removal chamber 140 to urge the liquid through the hydrophilic material 150 into the liquid conduit 160. At the same time, pressure in the liquid conduit 160 may be sufficiently high as to prevent gas from entering the liquid conduit 160. Use of the liquid conduit 160 allows capture of the separated liquid and may facilitate reuse of the liquid. For example, when the liquid in the liquid conduit 160 includes water, it may be directed to a system that processes the liquid to produce drinking water. Together, the liquid removal chamber 140 defined by the hydrophilic material 150 and the liquid conduit 160 form a liquid capture portion 145 of the passive phase separator 100 and may be modular according to exemplary embodiments.

As such, a different liquid capture portion 145 may be affixed (e.g., screwed, adhered) into the passive phase separator 100 as needed. The size and shape of the liquid removal chamber 140, as well as characteristics (e.g., material) of the hydrophilic material 150 and the sizing of the liquid conduit 160 may be selected based on an expected flow rate and amount of liquid (e.g., slug concentration). For example, if high liquid concentrations (i.e., slugs) are expected frequently at a high flow rate, this may suggest a relatively larger liquid removal chamber 140 to store the liquid, a hydrophilic material 150 with a higher permeability, and a larger liquid conduit 160 to hold and channel that liquid.

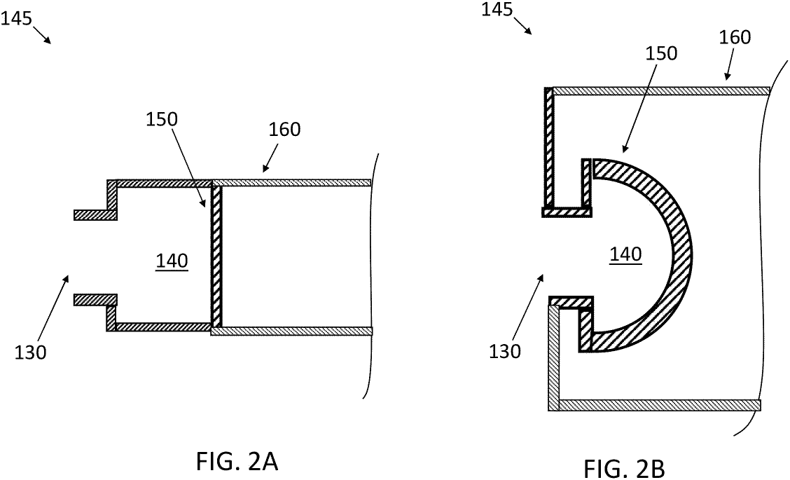

FIGS. 2A and 2B are cross-sectional views of a liquid capture portion 145 of a passive phase separator 100 according to two exemplary embodiments. The figures illustrate some of the aspects that may be modified in the modular liquid capture portion 145 according to different embodiments. The liquid removal chamber 140 is shaped differently in the exemplary embodiment of FIG. 2A than in the exemplary embodiment of FIG. 2B. The exemplary shapes are not intended to limit alternate shapes that may be used for the liquid removal chamber 140.

FIG. 2A illustrates that only a portion of the perimeter of the liquid removal chamber 140 may be hydrophilic (e.g., be coated with or formed from hydrophilic material 150). In the exemplary illustration of FIG. 2A, one of the perimeter walls is hydrophilic. FIG. 2A also illustrates that the liquid conduit 160 may be shaped and sized based on which of the perimeter walls of the liquid removal chamber 140 are hydrophilic. For example, the liquid conduit 160 has a larger volume in the exemplary embodiment of FIG. 2B as compared with the exemplary embodiment of FIG. 2A. This is, at least in part, because the liquid conduit 160 in FIG. 2A only obtains an inflow of liquid from one of the perimeter walls of the liquid removal chamber 140, while the liquid conduit 160 in FIG. 2B experiences an inflow of liquid from all around the liquid removal chamber 140. The different volumes of the liquid conduit 160 may additionally be because the flow rate or amount of liquid is expected to be higher when the modular liquid capture portion 145 shown in FIG. 2B is used, for example.

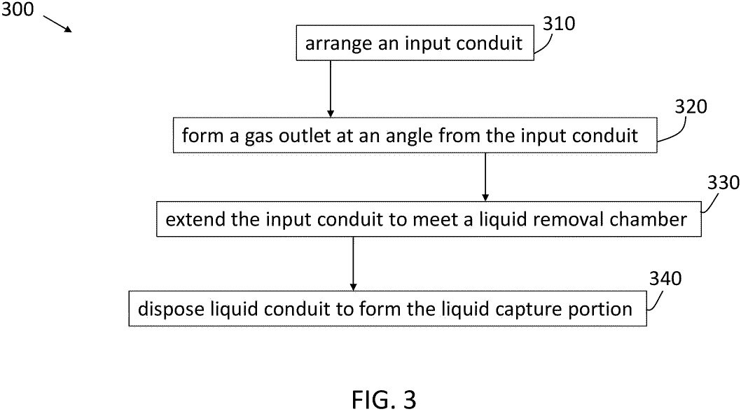

FIG. 3 is a process flow of a method 300 of fabricating a passive phase separator 100 with a liquid removal chamber 140 according to one or more embodiments. At block 310, arranging an input conduit 110 may include disposing the inlet 105 of the input conduit 110 to receive a multi-phase flow such as a two-phase flow of liquid and gas. The input conduit 110 may be fabricated from or coated with hydrophobic material 115. At block 320, forming a gas conduit 120 at an angle θ from the input conduit 110 may refer to forming the gas conduit 120 perpendicular to the input conduit 110, as shown in FIG. 1. As previously noted, other angles θ may be formed based on characteristics expected for the incoming flow. At block 330, extending the input conduit 110 to meet a liquid removal chamber 140 refers to extending the input conduit to an inlet 130 of the liquid removal chamber 140. As shown in FIGS. 1, 2A, and 2B, the liquid removal chamber 140 is in line with the input conduit 110, unlike the gas conduit 120, which is at an angle with the input conduit 110.

The liquid removal chamber 140 may have one or more perimeter walls coated with or formed from hydrophilic material 150. As shown in FIGS. 2A and 2B, the shape and size of the liquid removal chamber 140 may vary. At block 340, disposing the liquid conduit 160 to form the liquid capture portion 145 refers to sizing and shaping the liquid conduit 160 based on the size and shape of the hydrophilic material 150 around the liquid removal chamber 140, the volume of liquid expected to enter via the hydrophilic material 150 from the liquid removal chamber 140, as well as the rate at which the liquid is expected to flow through the liquid conduit 160. According to exemplary embodiments, the liquid capture portion 145 may be modular and, thus, replaceable based on, for example, multi-phase flow characteristics.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A passive phase separator comprising:
an input conduit including an inlet through which multi-phase flow enters the input conduit;
a gas conduit formed at an angle from the input conduit; and
a liquid removal chamber formed in line with the input conduit, wherein the gas conduit is closer to the inlet than the liquid removal chamber, the liquid removal chamber is configured to hold liquid from the multi-phase flow, and the gas conduit is configured to carry gas from the multi-phase flow.

2. The passive phase separator according to claim 1, further comprising hydrophilic material defining some or all of a perimeter of the liquid removal chamber, wherein the hydrophilic material is configured to attract and pass through the liquid that is water or water-based.

3. The passive phase separator according to claim 2, wherein the input conduit includes a liquid inlet that forms an opening of the liquid removal chamber on a side of the input conduit opposite the side of the inlet.

4. The passive phase separator according to claim 2, further comprising a liquid conduit configured to couple to the liquid removal chamber, wherein the liquid that passes through the hydrophilic material enters a volume of the liquid conduit.

5. The passive phase separator according to claim 4, wherein the liquid removal chamber and the liquid conduit form a liquid capture portion.

6. The passive phase separator according to claim 5, wherein the liquid capture portion is modular and replaceable.

7. The passive phase separator according to claim 1, wherein the angle is 90 degrees.

8. The passive phase separator according to claim 1, wherein the angle is less than 180 degrees.

9. The passive phase separator according to claim 1, wherein some or all of the input conduit or the gas conduit is formed from or coated with a hydrophobic material.

10. A method of assembling a passive phase separator, the method comprising:
arranging an input conduit with an inlet through which multi-phase flow enters the input conduit;
forming a gas conduit at an angle from the input conduit; and
forming a liquid removal chamber in line with the input conduit, wherein the gas conduit is closer to the inlet than the liquid removal chamber, the liquid removal chamber is configured to hold liquid from the multi-phase flow, and the gas conduit is configured to carry gas from the multi-phase flow.

11. The method according to claim 10, further comprising defining some or all of a perimeter of the liquid removal chamber with a hydrophilic material, wherein the hydrophilic material is configured to attract and pass through the liquid that is water or water-based.

12. The method according to claim 11, further comprising forming an opening of the liquid removal chamber on a side of the input conduit opposite the side of the inlet as a liquid inlet.

13. The method according to claim 11, further comprising arranging a liquid conduit to couple to the liquid removal chamber, wherein the liquid that passes through the hydrophilic material enters a volume of the liquid conduit.

14. The method according to claim 13, further comprising forming a liquid capture portion with the liquid removal chamber and the liquid conduit.

15. The method according to claim 14, wherein the forming the liquid capture portion includes the liquid capture portion being modular and replaceable.

16. The method according to claim 10, wherein the forming the gas conduit includes arranging the gas conduit at a 90 degree angle from the input conduit.

17. The method according to claim 10, wherein the forming the gas conduit includes arranging the gas conduit at the angle less than 180 degrees from the input conduit.

18. The method according to claim 9, further comprising determining a shape and size of the liquid removal chamber based on characteristics of the multi-phase flow.

19. The method according to claim 18, wherein the multi-phase flow is a flow of water and air and the characteristics include an expected increase in a concentration of the water in portions of the multi-phase flow.

20. The method according to claim 10, further comprising forming some or all of the input conduit or the gas conduit with a hydrophobic material or coating some or all of the input conduit or the gas conduit with the hydrophobic material.
